(19) United States
(12) Patent Application Publication
(10) Pub. No.: US 2011/0244968 A1
(43) Pub. Date: Oct. 6, 2011

(54) Flexible Coupler

(75) Inventor: Robin C.S. Chang, Taichung City (TW)

(73) Assignee: Apex Dynamics, Inc.

(21) Appl. No.: 12/798,143

(22) Filed: Mar. 30, 2010

(51) Int. Cl. F16D 3/64

(52) U.S. Cl. 464/79

(57) ABSTRACT

A flexible coupler includes an active element, a passive element and a flexible metal tube extending between the active and passive elements. The active element includes an internal side. The passive element includes an internal side. The flexible metal tube includes first and second annular end faces. Adhesive is provided between the internal side of the active element and the first annular face of the flexible metal tube. More adhesive is provided between the internal side of the passive element and the second annular face of the flexible metal tube.

### BACKGROUND OF INVENTION

1. Field of Invention

The present invention relates to a coupler for interconnecting two axles and, more particularly, to a flexible coupler.

2. Related Prior Art

A flexible coupler is used to interconnect two axles to compensate a centric error, an angular error and an axial error to reduce vibration in operation of the axles. There have been various flexible couplers.

Referring to FIG. 4, a conventional flexible coupler includes an active element 51, a passive element 52 and a flexible metal tube 53 extending between the active element 51 and the passive element 52. The active element 51 includes an annular groove 511 defined on a side. The passive element 52 also includes an annular groove 521 defined on a side. Adhesive is filled in the annular grooves 511 and 521. An end of the flexible metal tube 53 is inserted in the annular groove 511. Another end of the flexible metal tube 53 is inserted in the annular groove 521. The flexible metal tube 53 is supposed to be firmly connected to both of the active element 51 and the passive element 52 when the adhesive is cured. This might not happen because some of the adhesive would however be extruded or scratched from the annular groove 511 or 521 by the end of the flexible metal tube 53, which is thin, during the insertion of the end of the flexible metal tube 53 in the annular groove 511 or 521. Should inadequate adhesion occur, it would be difficult to transmit designed torque to the passive element 52 from the active element 51 for a designed period.

Referring to FIGS. 5 through 7, another conventional flexible coupler includes an active element 61, a passive element 62 and a flexible metal tube 63 extending between the active element 61 and the passive element 62. The active element 61 includes a main portion, a first annular flange portion 612 around the main portion, and a second annular flange 611 around the first annular shoulder 612. Similarly, the passive element 62 includes a main portion and first and second annular flanges.

A sleeve 613 is provided around the active element 61 before adhesive is provided between the sleeve 613 and the second annular flange 611 and between the sleeve 613 and the first annular flange 612. The adhesive is cured before a first end of the flexible metal tube 63 is inserted in a gap 614 between the sleeve 613 and the main portion of the active element 61. More adhesive is filled in the gap 614. The first end of the flexible metal tube 63 is firmly connected to the active element 61 after the adhesive in the gap 614 is cured.

Another sleeve 623 is provided around the passive element 62 before more adhesive is provided between the sleeve 623 and the first and second annular flanges of the passive element 62. The adhesive is cured before a second end of the flexible metal tube 63 is inserted in a gap 624 between the sleeve 623 and the main portion of the passive element 62. More adhesive is filled in the gap 624. The second end of the flexible metal tube 63 is firmly connected to the passive element 62 after the adhesive in the gap 624 is cured.

There could be a centric error between the sleeve 613 or 623 and the first annular flange of the active or passive element. There could also be a centric error between the first or second end of the flexible metal tube 63 and the main portion of the active or passive element. Accumulatively, these errors could affect the reduction of the vibration during the operation of this conventional flexible coupler. Moreover, the fabrication of this conventional flexible coupler could be expensive for including two steps of providing the glue.

The present invention is therefore intended to obviate or at least alleviate the problems encountered in prior art.

### SUMMARY OF INVENTION

It is the primary objective of the present invention to provide a reliable and inexpensive flexible coupling device.

To achieve the foregoing objective, the flexible coupler includes an active element, a passive element and a flexible metal tube extending between the active and passive elements. The active element includes an internal side. The passive element includes an internal side. The flexible metal tube includes first and second annular end faces. Adhesive is provided between the internal side of the active element and the first annular face of the flexible metal tube. More adhesive is provided between the internal side of the passive element and the second annular face of the flexible metal tube.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a cross-sectional view of a flexible coupler according to the preferred embodiment of the present invention;

FIG. 2 is an exploded view of the flexible coupler shown in FIG. 1;

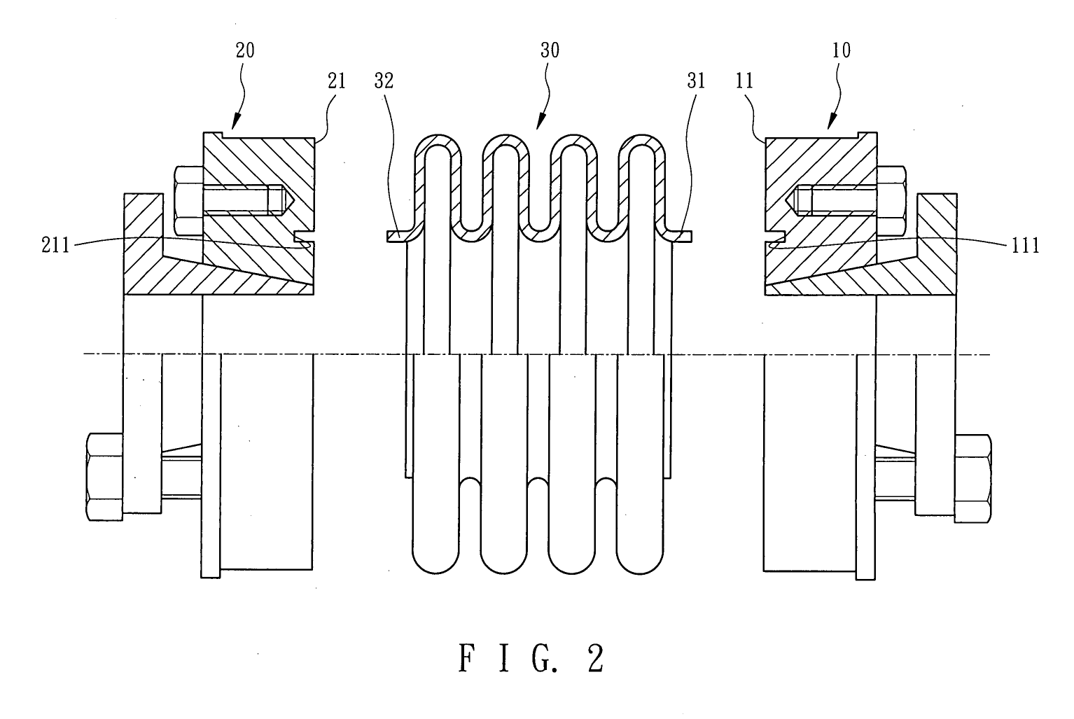

FIG. 3 is a cross-sectional view of a flexible coupler with a thicker layer of adhesive than shown in FIG. 1;

FIG. 4 is a cross-sectional view of a conventional flexible coupler;

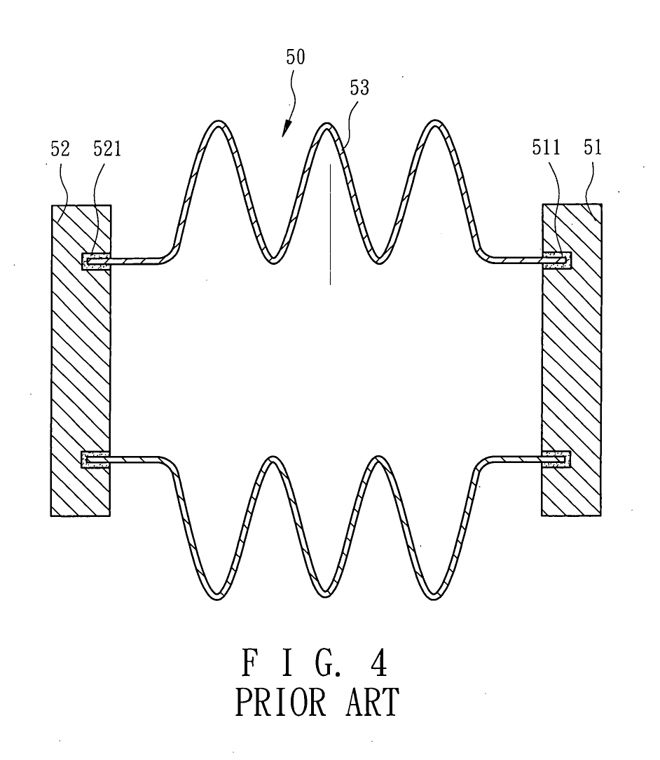

FIG. 5 is a cross-sectional view of another conventional flexible coupler;

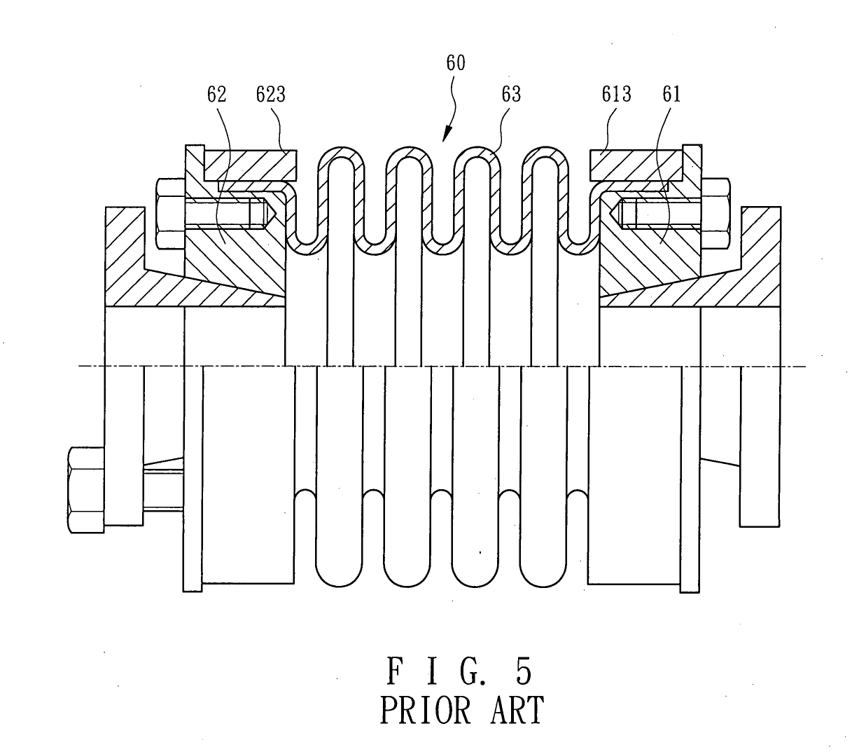

FIG. 6 is a partial view of the conventional flexible coupler shown in FIG. 5; and

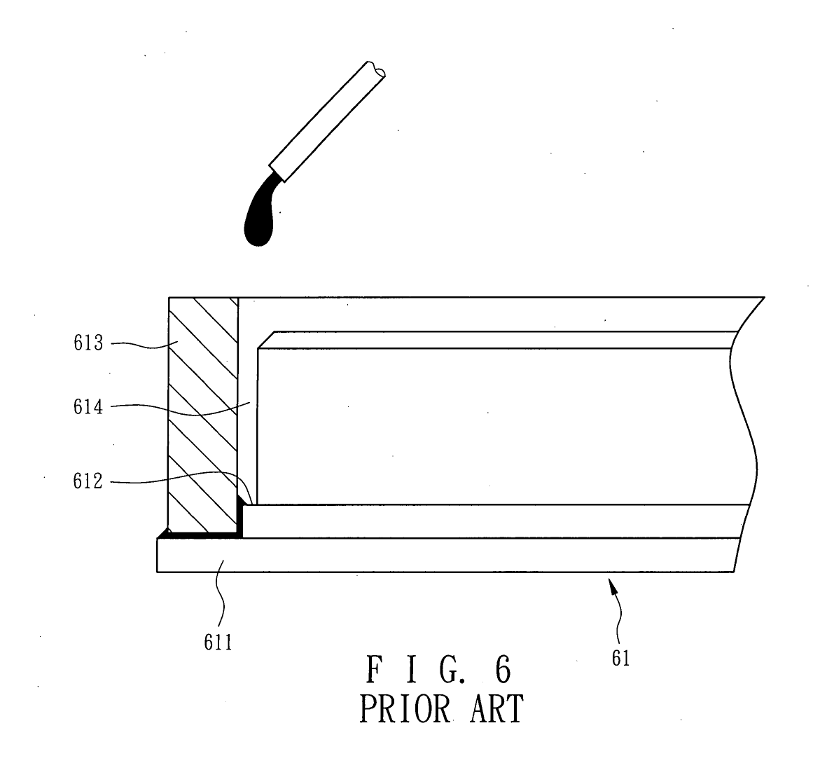

FIG. 7 is another partial view of the conventional flexible coupler shown in FIG. 5.

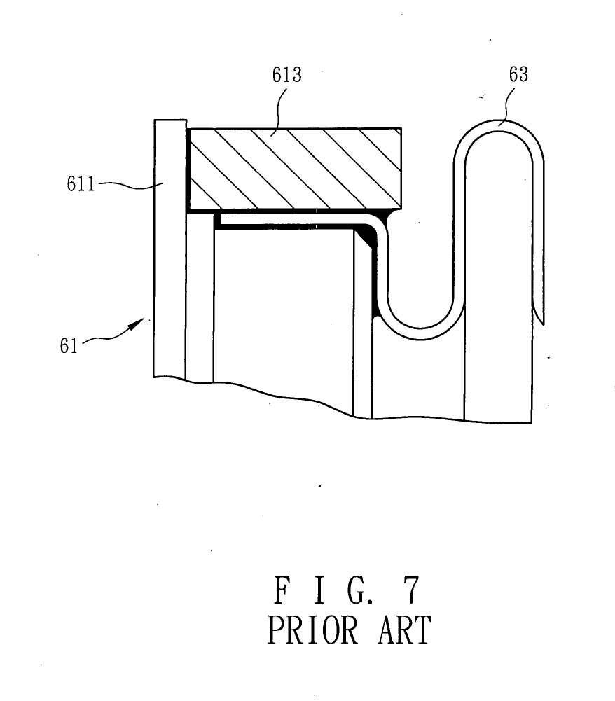

### DETAILED DESCRIPTION OF PREFERRED EMBODIMENT

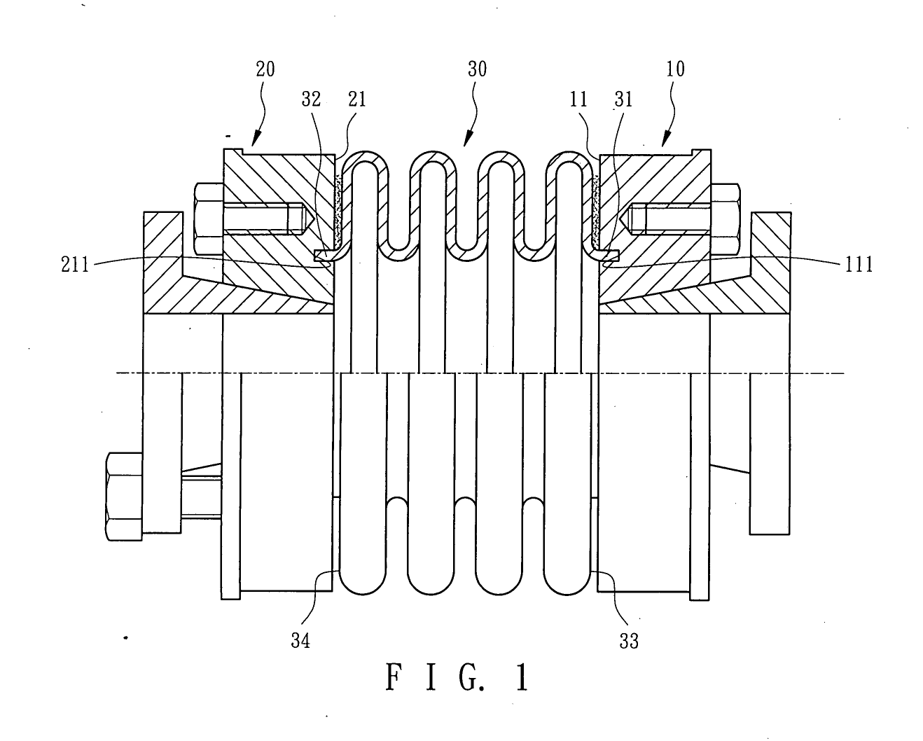

Referring to FIG. 1, a flexible coupler includes an active element 10, a passive element 20 and a flexible metal tube 30 extending between the active element 10 and the passive element 20 according to the preferred embodiment of the present invention. The active element 10 includes an annular groove 111 defined on an internal side 11. Similarly, the passive element 20 includes an annular groove 211 defined on an internal side 21.

The flexible metal tube 30 includes a first annular end face 33, a first tubular insert 31 extending from the first annular end face 33, a second annular end face 34, and a second tubular insert 32 extending from the second annular end face 34. The first tubular insert 31 extends around and along an axis of the flexible metal tube 30. The second tubular insert 32 extends around and along the axis of the flexible metal tube 30. The first annular end face 33 extends in a plane. The second annular end face 34 extends in another plane. The flexible metal tube 30 is made of aluminum, stainless steel or any other proper metal.

The first tubular insert 31 of the flexible metal tube 30 is inserted in the annular groove 11 of the active element 10 before glue is provided between the first annular end face 33 of the flexible metal tube 30 and the internal side 11 of the active element 10. The flexible metal tube 30 is firmly connected to the active element 10 after the adhesive is cured.

The second tubular insert 32 of the flexible metal tube 30 is inserted in the annular groove 21 of the passive element 20 before more glue is provided between the second annular end face 34 of the flexible metal tube 30 and the internal side 21 of the passive element 20. The flexible metal tube 30 is firmly connected to the passive element 20 after the adhesive is cured.

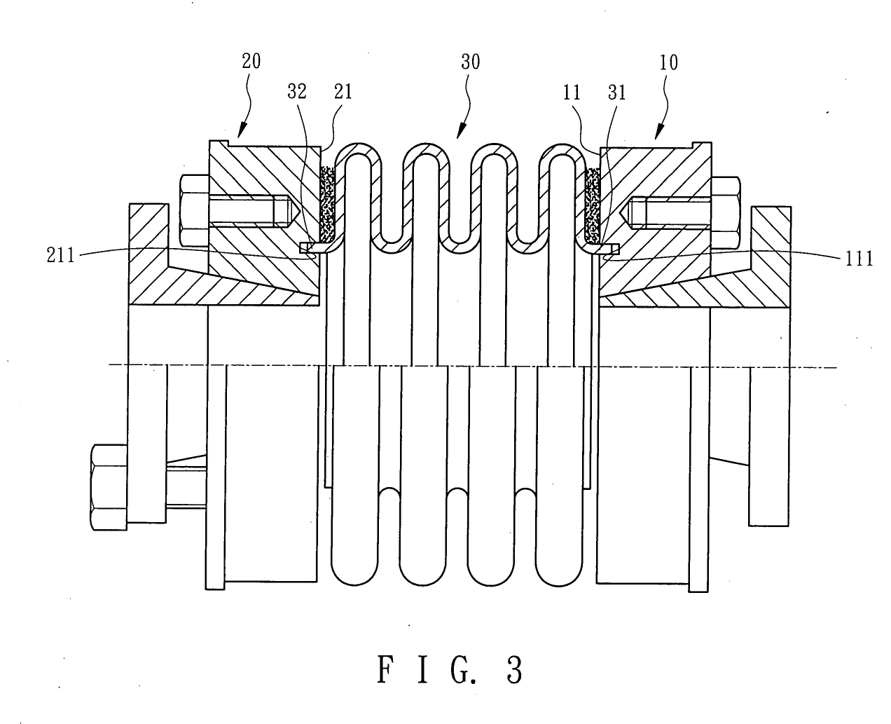

The thickness of the adhesive layer between the first annular end face 33 of the flexible metal tube 30 and the internal side 11 of the active element 10 is determined based on a designed value of torque to be transferred through the flexible coupler. The thickness of the adhesive layer between the second annular end face 34 of the flexible metal tube 30 and the internal side 21 of the passive element 20 is also determined based on the designed value of torque to be transferred through the flexible coupler. The thickness of the adhesive layers can be made thin by inserting a long section of the tubular insert 31 or 32 in the annular groove 111 or 211 as clearly shown in FIG. 1. The thickness of the adhesive layers can be made thick by inserting a short section of the tubular insert 31 or 32 in the annular groove 111 or 211 as clearly shown in FIG. 3.

The flexible coupler of the present invention exhibits several advantages. Firstly, there is no centric error between the first tubular insert 31 and the active element 10 or between the second tubular insert 32 and the passive element 20 because the thickness of the tubular insert 31 or 32 is identical to the width of the annular groove 111 or 211. This is possible only because no glue is filled in the annular groove 111 or 211.

Secondly, the cost is low for two reasons. At first, no sleeve is used. Moreover, the provision of the glue includes only one step.

Thirdly, the fabrication is precise and the operation is reliable because the thickness of the adhesive layer is under tight control. This is possible because no glue is extruded or scratched.

Fourthly, the intended value of torque can easily be adjusted for not having to change the size of any element.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A flexible coupler including an active element (10) formed with an internal side (11), a passive element (20) formed with an internal side (21), a flexible metal tube (30) formed with first and second annular end faces (31, 32), adhesive provided between the internal side (11) of the active element (10) and the first annular face (31) of the flexible metal tube (30), and more adhesive provided between the internal side (21) of the passive element (20) and the second annular face (32) of the flexible metal tube (30).

2. The flexible coupler according to claim 1, wherein the active element (10) includes an annular groove (111) defined on the internal side (11) thereof, wherein the flexible metal tube (30) includes a tubular insert (31) inserted in the annular groove (111) to position the flexible metal tube (30) on the active element (10).

3. The flexible coupler according to claim 1, wherein the passive element (20) includes an annular groove (211) defined on the internal side (21) thereof, wherein the flexible metal tube (30) includes a tubular insert (32) inserted in the annular groove (211) to position the flexible metal tube (30) on the passive element (20).

4. The flexible coupler according to claim 1, wherein the flexible metal tube (30) is made of aluminum.

5. The flexible coupler according to claim 1, wherein the flexible metal tube (30) is made of stainless steel.
